(19) United States
(12) Patent Application Publication
(10) Pub. No.: US 2008/0046644 A1
(43) Pub. Date: Feb. 21, 2008

(54) Method and System to Provide a Redundant Buffer Cache for Block Based Storage Servers

(76) Inventor: Kristof De Spiegeleer, Knokke-Heist (BE)

Correspondence Address: DLA PIPER US LLP, 2000 UNIVERSITY AVENUE, E. PALO ALTO, CA, 94303-2248, US

(21) Appl. No.: 11/838,156

(22) Filed: Aug. 13, 2007

Related U.S. Application Data
(60) Provisional application No. 60/822,381, filed on Aug. 15, 2006.

(51) Int. Cl. G06F 12/00; G06F 12/08

(52) U.S. Cl. 711/104; 711/118; 711/E12.083

(57) ABSTRACT

A block based storage system and method uses RAM memory to implement the buffers and is made redundant by replicating the buffer cache to an in-memory buffer cache on a separate caching unit. Replication can be done using one or more parity schemes (e.g. RAID 1, RAID 5, RAID 6) and/or other replication processes. In case of a power failure of the storage unit, the buffer cache is kept on the caching unit and the buffer cache is restored when the storage unit is available again, and normal operation is resumed

### PRIORITY CLAIM/RELATED APPLICATIONS

This application claims priority under 35 USC 119(e) and 120 to U.S. Provisional Patent Application Ser. No. 60/822,381 filed on Aug. 15, 2006 and entitled “Method and System to Provide a Redundant Buffer Cache for Block Based Storage Servers” which is incorporated herein by reference.

### FIELD

The invention is in the field of information technology and more particularly in the field of storage area network (SAN) based storage technology.

### BACKGROUND

Block based storage servers such as SAN servers (e.g. an IP protocol based SAN or any other type of SAN) receive blocks sent by clients that need to be written to disk on the storage server. The speed at which these blocks can be written depends on the disk speed and any delay in the writing of the blocks onto the disk causes latency for the clients. Latency is the time between the client sending the block and the client receiving a confirmation that the block is written and a new block can be sent.

The conventional systems and methods reduced the latency by introducing a buffer cache inside the storage server that was backed up using a battery to prevent data loss in case of a power failure. Using this conventional system with the buffer cache, the block is committed back to the client (a confirmation is sent back to the client) as soon as the block is written to the buffer cache, which is typically much faster than writing to disk so that the latency is reduced.

It is desirable to provide a buffer cache for storage system that obviates the need for the battery backup and that does not have the risk for data loss due to power failure and it is to this end the method and system described below are directed.

### BRIEF DESCRIPTION OF THE DRAWINGS

FIG. 1 is a schematic representation of a first example of a storage system having a client, a block based storage unit and two caching units;

FIG. 2 is a schematic overview of the buffer in a storage unit and the buffer in a caching unit;

FIG. 3 is a schematic overview of a second example of a storage system that has the buffer in a storage gateway and its communication with the client and the storage unit;

FIG. 4 is a schematic overview of a method to synchronously replicate the buffer of a storage unit to the buffer of a caching unit;

FIG. 5 is a schematic overview of a method to asynchronously replicate the buffer of a storage unit to the buffer of a caching unit; and

FIG. 6 is a schematic overview of a method to restore a storage unit buffer cache from a replicated buffer.

### DETAILED DESCRIPTION OF ONE OR MORE EMBODIMENTS

The system and method are particularly applicable to a client/server type architecture storage system that uses an IP network or other network for communications and it is in this context that the system and method are described. It will be appreciated, however, that the system and method has greater utility since it can be implemented using other known architectures (stand alone computer, mainframe computer, peer to peer system, etc.), and it can be implemented with hardware elements, software elements or a combination of hardware and software elements and all of the different architectures and technologies that can be used to implement the system and method are within the scope of the system and method.

The system incorporates a buffer cache which is implemented using random access memory (RAM) and which replicates the cache buffer inside a storage unit, such as a storage server for example, to an in-memory buffer cache located in a separate caching unit, such as a caching server for example, thereby eliminating the need for battery backups inside the storage unit. Hence, the storage system permits the building of a storage solution (for example an IP protocol based SAN) using cost effective commodity hardware, without the need for specific hardware such as a battery back up and without the risk of data loss due to a power failure, In addition, because RAM memory is used for the buffer cache, the buffer cache can be very large since RAM memory is relatively inexpensive.

The storage system may be a block-based storage unit, such as a SAN server (e.g. an IP protocol based SAN or any other SAN), that receives blocks from one or more clients, which need to be written to disk. Upon writing the block to the disk, the block is committed back to the source (client) to confirm the reception and acceptance of the block, allowing the source to send additional blocks. As stated above, the sending of a block and waiting for the commit causes latency and limits the speed at which data can be written to the block based device. In order to reduce latency, incoming blocks are typically buffered in memory by the storage server. In the storage system, a RAM memory is used within the storage unit to implement the buffer cache and using a RAM memory within one or more separate units (so called caching units that nay be for example servers) to replicate the buffer cache inside the storage unit, thereby eliminating the need of a battery backup inside the storage unit as was required by the conventional systems. In the storage system, the buffer cache inside the storage unit can be implemented using commodity hardware and both the storage unit and the caching unit can be implemented on commodity hardware and are therefore more cost efficient and easier to manage compared to current solutions. Thus, the hardware of the storage system can easily be maintained and replaced because commodity (readily available) hardware is used and the total cost of the storage system is lower compared to prior art, because no proprietary hardware is used.

The storage system may also incorporate a plurality of caching units so that the storage system can have additional redundancy wherein the storage unit buffer is replicated to multiple caching units at the same time. Then, if one caching unit becomes unavailable, another caching unit can be used to restore the buffer if needed. In one embodiment, if more than one caching unit is used, one or more different parity schemes can be used to write the data to the buffer caches with fault tolerance. These schemes may include redundant array of inexpensive drives (RAID) 1, RAID 5, RAID 6 and any other of one or more parity schemes which allows reconstruction of the data if one or more of the caching units become unavailable.

In another embodiment, the replication to multiple caching units is executed based on a hashing process. For each incoming block, a hash is calculated using MD5 or any other hashing process. Based on the resulting hash, the block is replicated to one of the caching units. The selection of the caching unit to replicate to, is made based on the first characters of the hash or any distribution process.

In another embodiment, the replication to multiple caching units is executed based on the actual load of the caching units. In this case, the caching unit with the lowest load will accept the replicated block.

In another embodiment, the replication to multiple caching units is executed based on the latency between the storage system and the caching units. The caching unit with the lowest latency will be selected to replicate the block to. In yet another embodiment, the different replication methods described above may also be combined together.

The storage system may use synchronous replication to replicate the storage unit buffer to multiple caching units or asynchronous replication to replicate the storage unit buffer to multiple caching units.

In a datacenter implementation of the storage system, caching units may be located in the same rack as the storage unit or in separate racks. In order to increase redundancy, caching units may optionally be located in separate racks and may optionally be fed using separate power systems or UPS systems.

The one or more caching units of the system may be interconnected with the one or more storage units using a high bandwidth and low latency protocol in order to minimize the latency introduced by replicating the storage server buffer to the caching units. In one embodiment, the known Infiniband protocol is used for the communication between the storage unit(s) and the one or more caching unit(s). In another embodiment, Ethernet, Fast Ethernet or Gigabit Ethernet is used to interconnect the storage unit(s) with its caching unit(s). Now, an exemplary storage system that implements the buffer cache is described.

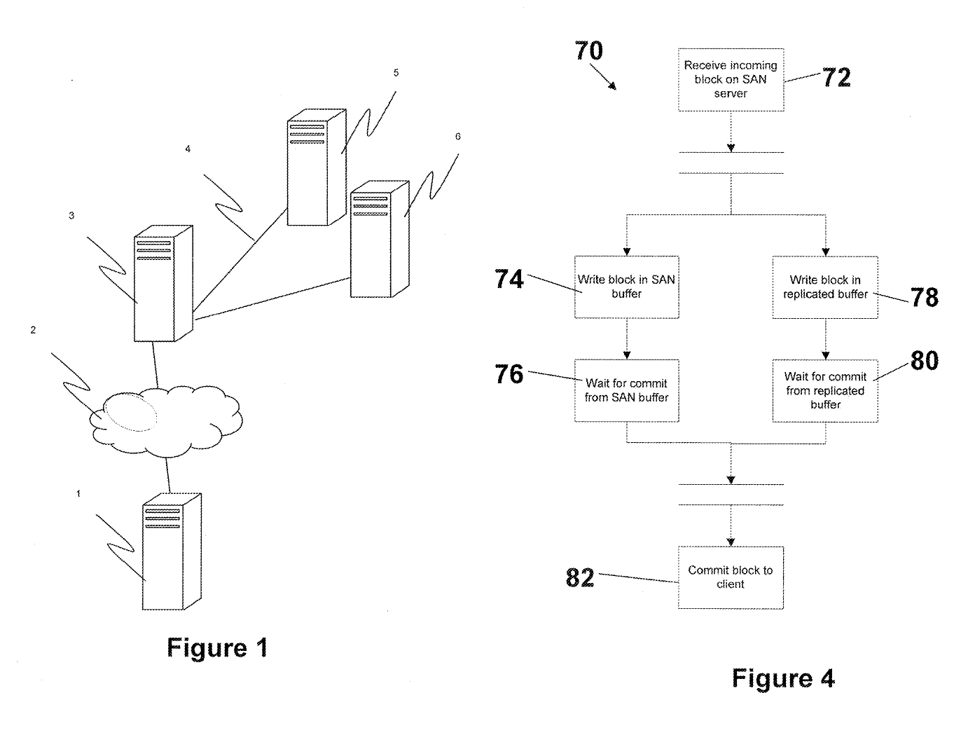

FIG. 1 illustrates an example of a storage system that incorporates the buffer cache. The system may include one or more clients 1 (a single client implemented as a server computer is shown in the example, but each client may be implemented in many different ways such as a personal computer, mobile device, etc, that are within the scope of the invention), a network 2 (which may be any communications or data network such as, for example, the Internet), one or more storage units 3 (a single storage unit implemented as a server computer is shown in the example, but each storage unit may be implemented in many different ways that are within the scope of the invention), a wired/wireless connection 4 and one or more caching units 5,6 (each caching unit implemented as a server link is shown in the example, but each caching unit may be implemented in many different ways that are within the scope of the invention) that are capable of being connected to the one or more storage units by the link 4. In the storage system, the client may be reading from and writing to the storage unit 3 over the network 2. A buffer cache (not shown) in the storage unit is replicated to caching units 5, 6.

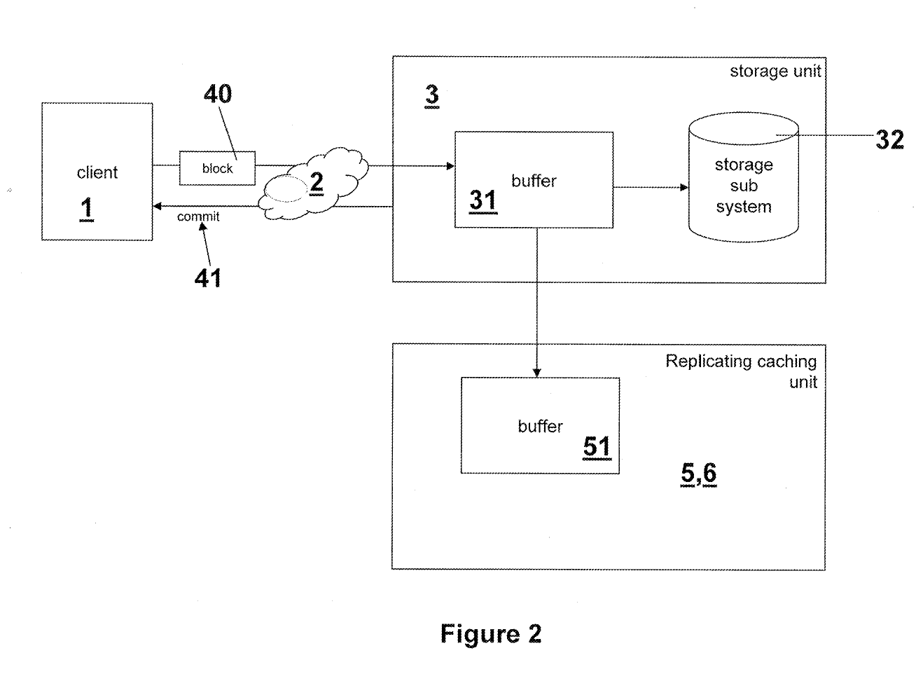

FIG. 2 illustrates more details of the storage system and shows the typical storage process that occurs with the storage unit. As shown in FIG. 2, each storage unit 3 may further include a buffer 31 (implemented using random access memory in one embodiment) and a storage device 32, such as a disk sub-system that stores the data of the storage unit. Each caching unit 5,6 may also have a buffer 51 (implemented using random access memory in one embodiment). In the embodiment shown in FIG. 2, the elements of the storage system are implemented using commodity hardware. As described above in FIG. 1, the caching unit(s) are interconnected with the storage units using a high bandwidth and low latency protocol in order to minimize the latency introduced by replicating the storage server buffer to the caching servers. In one embodiment, Infiniband is used for the communication between the storage device and the caching units. In another embodiment, Ethernet, Fast Ethernet or Gigabit Ethernet is used to interconnect the storage unit(s) with its caching unit(s). As storage system shown in FIGS. 1 and 2 may be a block based storage system in which a block 40 is sent to the storage unit by the client and written into the buffer 31 so that a commit indicator 41 is sent back to the client indicating that the storage of that block has been completed (from the client's perspective) once the buffer store operation is completed which reduces the latency of the storage system. The block stored in the buffer may be later stored in the storage device 32.

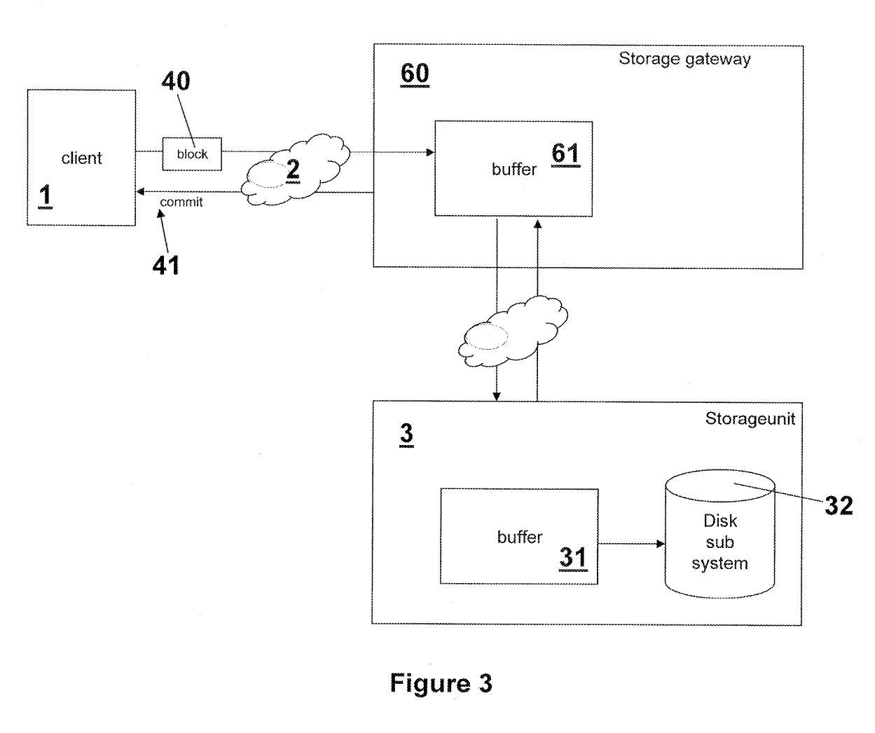

FIG. 3 illustrates a second example of the storage system that has similar elements to the storage system shown in FIG. 2 (and like elements have the same reference number and operate as described above) and further includes a storage gateway 60 that has a buffer 61 therein and is capable of being connected to the storage unit 3 via the network. The storage gateway may consist of one or more commodity servers, interconnected using a high speed network such as Infiniband, Gigabit or any other network protocol. In operation, the client 1 writes the block 40 to the to the storage gateway 60. The block 40 is committed to the client upon writing to the buffer cache 61 inside the storage gateway to reduce latency. The storage gateway asynchronously writes the block to the storage unit 3. The storage gateway also caches blocks which are read by the client 1. The storage gateway 60 uses RAM memory to implement the buffer cache 61. The data is written to the buffer caches in the nodes of the storage gateway, using a parity scheme such as RAID 1, RAID 5, RAID 6 or any other parity scheme.

The storage system shown in FIG. 1-3 may use various methods to replicate a storage unit buffer cache to a buffer cache in one or more cache unit(s). For example, the storage system may use a synchronous replicating scheme or an asynchronous replication scheme for example. In the synchronous replication scheme, every block which is received by the storage unit is written to the storage unit buffer cache and at the same time to the replicated buffer, whereby the block is committed back to the client upon successful writing of the block to both the storage unit buffer cache and the replicated unit butter cache. In the asynchronous replication scheme, the storage unit buffer cache is replicated independent of blocks being received by the storage unit. In particular, every block which is received by the storage unit is written to the storage buffer and committed back to the clients without waiting for the block to be written in the cache unit buffer. In the asynchronous scheme, the storage unit buffer is copied to the replicated unit buffer page by page, whereby a page can be both larger in size or smaller in size than a block received by the storage unit.

FIG. 4 illustrates an example of a synchronous replication scheme that may be used by the storage system shown in FIG. 1-3. The method described may be implemented by one or more lines of computer code being executed on one or more processing units of the storage system, such as one or more processors in the storage unit and the caching unit or storage gateway. In the scheme, the storage unit/storage gateway may receive an incoming block from a client (72). Then, the storage unit may write the block in the buffer of the storage unit (74) and wait for a commit indication from the storage unit buffer (76). The caching unit may also write the block into the caching unit buffer (78) and then wait for the commit indication from the caching unit buffer (80). Once the commit indications are received from both the storage unit buffer and the caching unit buffer, the storage unit (in FIG. 2) or the storage gateway may send a commit indication for the block back to the client (82) so that the latency between the client and the storage system is minimized.

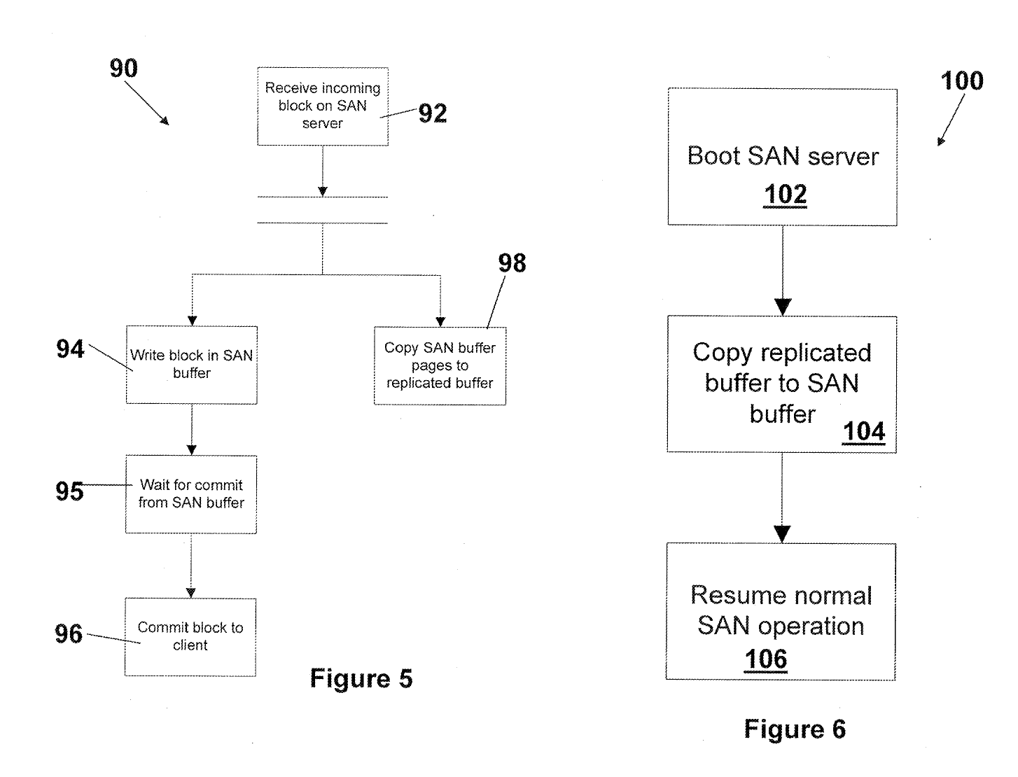

FIG. 5 illustrates an example of an asynchronous replication scheme 90 that may be used by the storage system shown in FIG. 1-3. The method described may be implemented by one or more lines of computer code being executed on one or more processing units of the storage system, such as one or more processors in the storage unit and the caching unit or storage gateway. In the scheme, the storage unit/storage gateway may receive an incoming block from a client (92). Then, the storage unit writes the block in the storage unit buffer (94) and waits for the commit indication from the storage unit buffer (95). Once the commit indication is received from the storage unit buffer, the storage unit (FIG. 2) or the storage gateway may send a commit indication for the block back to the client (96) so that the latency between the client and the storage system is minimized. In this asynchronous method, the storage unit buffer is copied asynchronously (98) to the caching unit buffer/storage gateway buffer page by page. In this method, the storage in the caching unit buffer occurs at a different time than the time when the block is stored in the storage unit buffer.

FIG. 6 illustrates a method 100 to restore the buffer in a storage unit from a caching unit buffer. In the method, after the storage unit has lost power/failed, the storage unit is booted after some downtime (102) and then the caching unit buffer at the one or more caching units (depending on the replication scheme if any) is copied over to the storage unit buffer (104). Once this is completed, the storage unit can resume normal storage operations (106) such as accepting new blocks from the one or more clients. The method shown in FIG. 6 is used to recover from a downtime of the storage unit, for example after a power outage which infected the storage unit.

As described above, the system may also implement fault tolerance when using a plurality of caching units, In particular, various parity schemes can be used to write the data to the buffer caches with fault tolerance. The parity schemes may include RAID 1, RAID 5, RAID 6 and any other parity scheme which allows reconstruction of the data if one or more nodes become unavailable. In case one or more nodes become unavailable, the data is reconstructed based on the parity information, and reconstructed data can be committed to the storage unit.

While the foregoing has been with reference to a particular embodiment of the invention, it will be appreciated by those skilled in the art that changes in this embodiment may be made without departing from the principles and spirit of the invention, the scope of which is defined by the appended claims.

1. A block based storage system, comprising:
a storage unit that is capable of storing a plurality of blocks of data in a storage device, the storage unit further comprising a memory and a buffer resident in the memory that caches blocks of data provided to the storage unit; and
a storage gateway having a memory and a buffer resident in the memory wherein each buffer stores at least a portion of the blocks of data stored in the buffer of the storage unlit to reduce the latency of block storage in the storage unit.

2. The system of claim 1, wherein the storage unit further comprises a server computer and the storage gateway further comprises at least one server computer.

3. The system of claim 1, wherein the memory in the storage unit further comprises a random access memory and wherein the memory in the storage gateway further comprises a random access memory.

4. The system of claim 1, wherein the storage gateway further comprises two or more caching units wherein each caching unit has a memory and a buffer resident in the memory wherein each buffer stores at least a portion of the blocks of data stored in the buffer of the storage unit.

5. The system of claim 4, wherein each of the blocks of data are stored in the buffer resident in the memory of the caching units using a parity scheme.

6. The system of claim 5, wherein the parity scheme further comprises RAID 1, RAID 5 or RAID 6.

7. The system of claim 4, wherein each of the blocks of data are replicated to the buffer resident in the memory of one of the caching units using a hash-based process, where said hash-based process further comprises calculating a hash of said blocks of data and selecting one of the caching units based on said hash.

8. The system of claim 4, wherein each of the blocks of data are replicated to the buffer resident in the memory of one of the caching units where the caching unit has the lowest load.

9. The system of claim 4, wherein each of the blocks of data are replicated to the buffer resident in the memory of one of the caching units where said caching unit is selected based on a lowest latency between said storage unit and said caching unit.

10. A method for storing data in a block based storage system, comprising:
receiving a block of data to be stored in the storage system;
caching the block of data in a random access memory buffer in a storage unit; and
sending a commit indication back to the client once the block of data is stored in the random access memory buffer of the storage unit.

11. The method of claim 10 further comprising replicating the block of data in the random access memory buffer to a random access memory buffer in a caching unit to provide redundancy.

12. The method of claim 11, wherein the replicating the block of data in the random access memory buffer further comprises sending the commit indication back to the client once the block of data is stored in both the random access memory buffer in the storage Unit and the random access memory buffer in the caching unit.

13. The method of claim 11, wherein the replicating the block of data in the random access memory buffer further comprises sending the commit indication back to the client once the block of data is stored in the random access memory buffer in the storage unit and asynchronously copying the block of data into the random access memory buffer of the caching unit.

14. The method of claim 11, wherein the replicating the block of data in the random access memory buffer further comprises implementing a parity scheme to provide redundant data storage.

15. The method of claim 14, wherein the parity scheme further comprises RAID 1, RAID 5 or RAID 6.

16. The method of claim 11, wherein replication the block of data further comprises implementing a hash-based process to replicate the block of data that further comprises calculating a hash of said blocks of data and selecting one of the caching units based on said hash.

17. The method of claim 11, wherein replicating each of the blocks of data further comprises replicating the each of the blocks of data to a buffer resident in the memory of one of the caching units that has the lowest load is selected.

18. The method of claim 11, wherein replicating each of the blocks of data further comprises replicating the each of the blocks of data to a caching unit selected based on the lowest latency between said storage unit and said caching unit.
